(19) United States
(12) Patent Application Publication
(10) Pub. No.: US 2003/0158934 A1
(43) Pub. Date: Aug. 21, 2003

(54) Condition monitor and controller for a server system

(76) Inventor: Ben Chang, Taipei (TW)

Correspondence Address: BIRCH STEWART KOLASCH & BIRCH, PO BOX 747, FALLS CHURCH, VA, 22040-0747, US

(21) Appl. No.: 10/062,479

(22) Filed: Feb. 5, 2002

(51) Int. Cl. G06F 15/173

(52) U.S. Cl. 709/224; 710/305

(57) ABSTRACT

A system for monitoring and controlling a plurality of motherboards of a server through a system management unit. The system includes at least a plurality of logic transform units, an polling logic unit, a system connection back plane and a status display unit. Remote monitoring and system control can also be attained by a remote computer. The remote monitor and control system includes at least a plurality of logic transform units, an polling logic unit, a system connection back plane, a status display unit and a remote managing logic unit.

### BACKGROUND OF THE INVENTION

1. Field of the Invention

The invention generally relates to a system for monitoring and controlling the status of a server computer, and more particularly relates to a system for monitoring and controlling the status of a plurality of motherboards of the server.

2. Related Art

In a network system, a server provides specific services, such as database, file saving, printers, emails or web pages, for each client or terminal. In order to serve a plurality of clients, the server has to manage information coming from each client and suitably respond to every request. Therefore, the hardware of the server has to include several input and output ports; and the software has to manage the information of several clients.

When serving a large number of clients, the load of the hardware and software becomes more difficult to manage. Therefore, for a server with a large workload, it is an important task for engineers to design a better management system with simpler hardware that is capable of serving more clients at a time.

To serve a plurality of clients, an intensive server has been developed to incorporate a plurality of motherboards that each serve a specific function. In this manner, the server system only has to manage the motherboards, which simplifies its job. A system management unit is applied to manage the plurality of motherboards.

However, since the management unit has to monitor the status of each motherboard and controls accordingly, each motherboard has to provide a status signal to the management unit, and the management unit has to provide control signals to each motherboard. Each status or control signal requires a specific wire. Therefore, the more clients a server has to serve, the more wires and interfaces it has to use. The large amount of wires and interfaces occupies a large space and also costs a lot of money.

### SUMMARY OF THE INVENTION

An object of the invention is therefore to provide a system and method of a server for monitoring and controlling a plurality of motherboards of the server. The monitor and control system of the invention require less space for the interface, and cost less money.

Another object of the invention is to provide a system for monitoring and controlling a plurality of motherboards of the server through a system management unit. The system includes at least a plurality of logic transform units, an polling logic unit, a system connection back plane and a status display unit. Each motherboard includes a logic transform unit, which is composed of a parallel to serial logic unit for transferring the status signal to the system management unit of the server; and a serial to parallel logic unit for transferring the control signals of the system management unit to the motherboard. The polling logic unit included in the system management unit is used to receive and transfer the status signal of the specific motherboard transformed by the logic transform unit, and to transfer the control signal of the system management unit to the logic transform unit. The system connection back plane connects the logic transform units and the polling logic unit. The status display unit included in the system management unit is connected with the polling logic unit. The status display unit receives the status signals of the motherboards and displays the status of the motherboards.

A further object of the invention is to provide a system for monitoring and controlling a plurality of motherboards of a server through a system management unit and a remote computer. The system includes at least a plurality of logic transform units, an polling logic unit, a system connection back plane, a status display unit and a remote managing logic unit. Each motherboard includes a logic transform unit, which is composed of a parallel to serial logic unit for transferring the status signal to the system management unit of the server; and a serial to parallel logic unit for transferring the control signals of the system management unit to the motherboard. The polling logic unit included in the system management unit is used to receive and transfer the status signal of the specific motherboard transformed by the logic transform unit, and to transfer the control signal of the system management unit to the logic transform unit. The system connection back plane connects the logic transform units and the polling logic unit. The status display unit included in the system management unit is connected with the polling logic unit. The status display unit receives the control signals of the remote computer, transfers the signals to the motherboards, receives the status signals of the motherboards and transfers the signals to the remote computer.

Further scope of applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

The invention will become more fully understood from the detailed description given hereinbelow. However, this description is for purposes of illustration only, and thus is not limitative of the invention.

### BRIEF DESCRIPTION OF THE DRAWINGS

FIG. 1 is a systematic block diagram of an intensive server according to the invention;

FIG. 2 is a block diagram of a first embodiment of a monitoring and controlling system for a server according to the invention;

FIG. 3 is a block diagram of a second embodiment of the invention;

FIG. 4 is a detailed block diagram of the first embodiment of the invention; and

FIG. 5 is a detailed block diagram of the second embodiment of the invention.

### DETAILED DESCRIPTION OF THE INVENTION

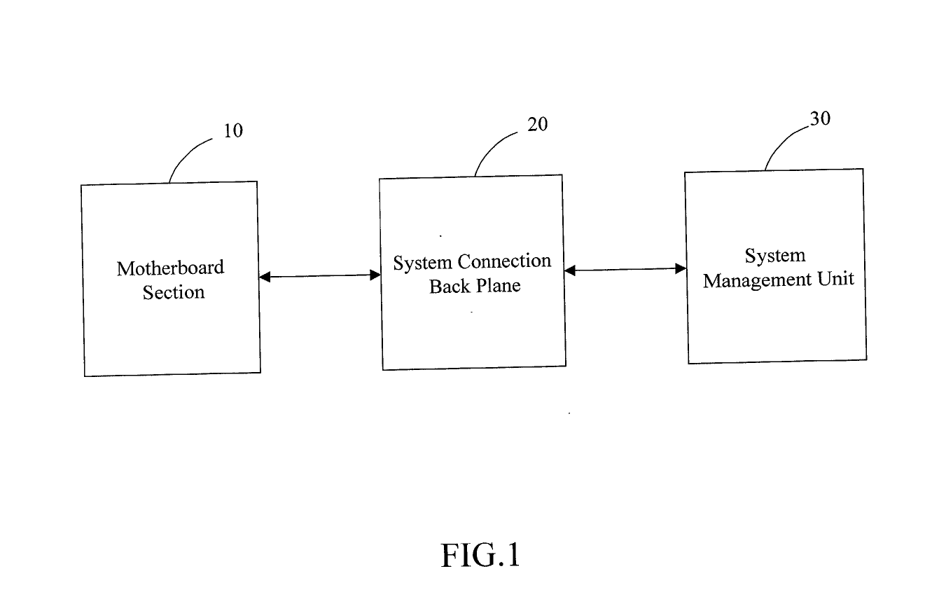

As shown in FIG. 1, an intensive server according to the invention includes a motherboard section 10, a system connection back plane 20 and a system management unit 30. The motherboard section 10 includes a plurality of motherboards that each perform a specific function. The motherboard section 10 and the system management unit 30 are connected with the system connection back plane 20 through wires. The object of the invention is to provide the simplest possible wiring for the system management unit 30 to monitor and control all the motherboards in the motherboard section 10.

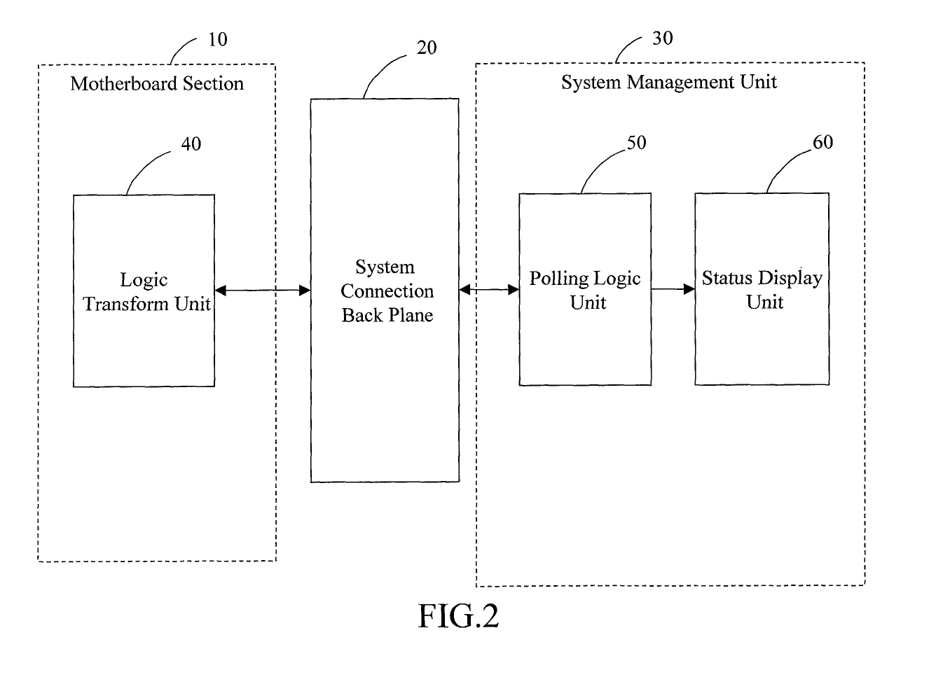

Please refer to FIG. 2, which shows a block diagram of a first embodiment of the invention. A system for monitoring and controlling a plurality of motherboards of a server includes a plurality of logic transform units 40, an polling logic unit 50, a system connection back plane 20 and a status display unit 60. Each motherboard mounted in a motherboard section 10 includes a logic transform unit 40. The logic transform units 40 is connected with the system connection back plane 20. The polling logic unit 50 and the status display unit 60 are included in the system management unit 30. The polling logic unit 50 is connected with the system connection back plane 20. The status display unit 60 is connected with the polling logic unit 50.

Each logic transform unit 40 included in each motherboard is used to transfer the status signal of the motherboard to the polling logic unit 50 of the system management unit 30 through the system connection back plane 20. The polling logic unit 50 requests the status signals of each motherboard, and displays the status of the motherboards on the status display unit 60. Specific identification codes are provided by the motherboards to the logic transform units 40 for identification of the boards. The polling logic unit 50 transfers the control signal of the system management unit 30 to the logic transform unit 40 of a designated motherboard through the system connection back plane 20. Therefore, the motherboards can be controlled.

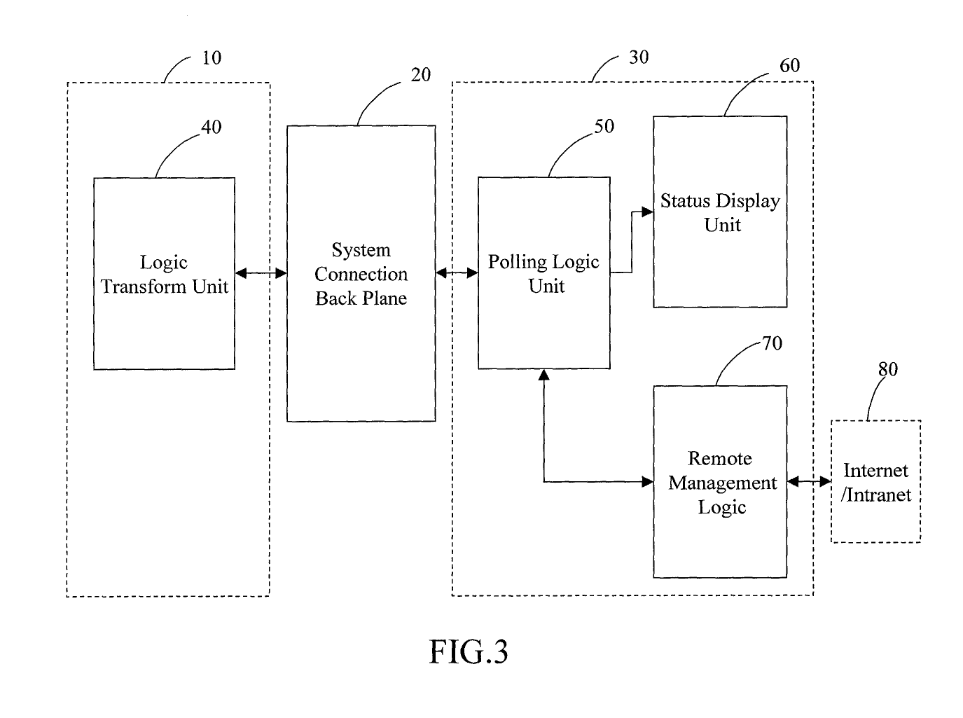

Referring to FIG. 3, a block diagram of a second embodiment of the invention, a system for monitoring and controlling a plurality of motherboards of a server includes a plurality of logic transform units 40, an polling logic unit 50, a system connection back plane 20, a status display unit 60 and a remote managing logic unit 70. Each motherboard mounted in a motherboard section 10 includes a logic transform unit 40. The logic transform units 40 are connected with the system connection back plane 20. The polling logic unit 50, the status display unit 60 and the remote managing logic unit 70 are included in the system management unit 30. The polling logic unit 50 is connected with the system connection back plane 20. The status display unit 60 is connected with the polling logic unit 50. The remote managing logic unit 70 is also connected with the polling logic unit 50. The remote managing logic unit 70 is connected to a remote computer via the Internet or an Intranet 80.

Each logic transform unit 40 included in each motherboard is used to transfer the status signal of the motherboard to the polling logic unit 50 of the system management unit 30 through the system connection back plane 20. The polling logic unit 50 requests the status signals of each motherboard, and displays the status of the motherboards on the status display unit 60. Specific identification codes are provided by the motherboards to the logic transform units 40 for identification of the boards. The polling logic unit 50 transfers the control signal of the system management unit 30 to the logic transform unit 40 of a designated motherboard through the system connection back plane 20. Therefore, the motherboards can be controlled.

As shown in FIG. 3, the remote managing logic unit 70 is connected with the Internet or an Intranet 80 so that the motherboards of the server can be monitored and controlled through a remote computer. In other words, the remote managing logic unit 70 receives the status signals of the motherboards through the polling logic unit 50, and transfers the control signals of the remote computer.

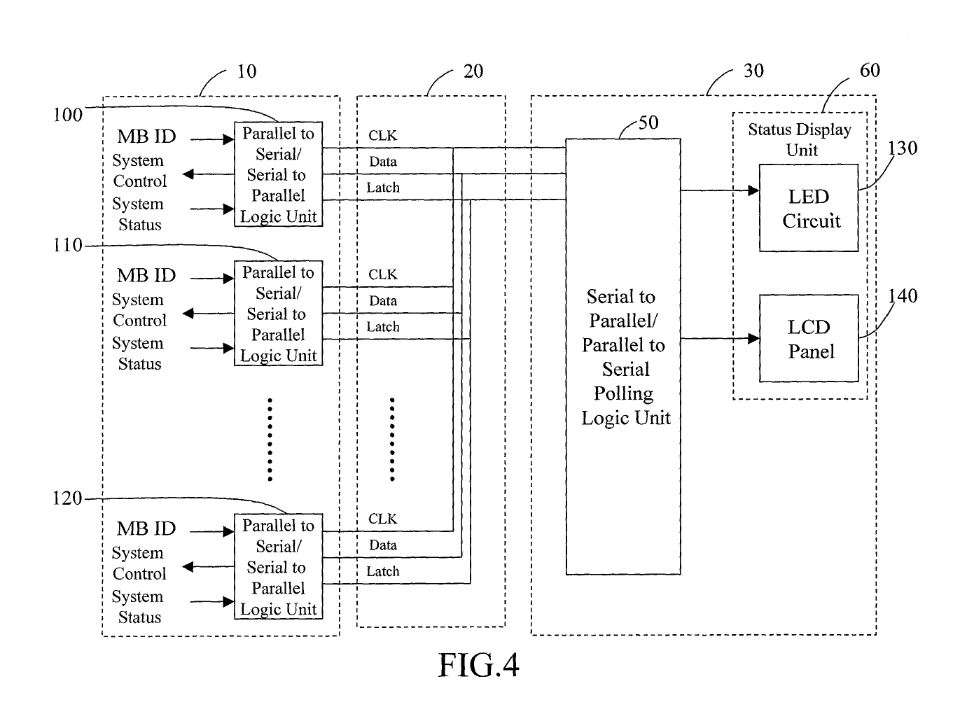

FIG. 4 is a detailed block diagram of the first embodiment of the invention. There are a plurality of parallel to serial logic units and serial to parallel logic units 100, 110, 120, etc. included in the motherboard section 10. These parallel to serial logic units and serial to parallel logic units are the logic transform units 40 illustrated in FIG. 2. In other words, each logic transform unit 40 includes a parallel to serial logic unit and a serial to parallel logic unit. Each parallel to serial logic/serial to parallel logic unit 100, 110 or 120 includes three output lines: a clock line, a data line and a latch line. The clock lines of each parallel to serial logic/serial to parallel logic unit are connected to the polling logic unit 50 parallel to one another. The data lines of each parallel to serial logic/serial to parallel logic unit are connected to the polling logic unit 50 parallel to one another. The latch lines are also connected to the polling logic unit 50 parallel to one another. The status display unit 60 includes a light-emitting diode (LED) circuit 130 and a liquid crystal display (LCD) panel 140 for displaying the status signals of the motherboards.

In FIG. 4, each parallel to serial logic/serial to parallel logic unit 100, 110 or 120 is used to transfer the status signal of a motherboard to the serial to parallel logic unit included in the polling logic unit 50 through the system connection back plane 20. Finally, the status of the motherboard is displayed on the LED or LCD. Furthermore, each parallel to serial logic/serial to parallel logic unit 100, 110 or 120 is used to receive the control signal of the system management unit 30, which is transferred by the polling logic unit 50. As a result, the system management unit 30 can monitor and control the motherboards of the server through these three lines.

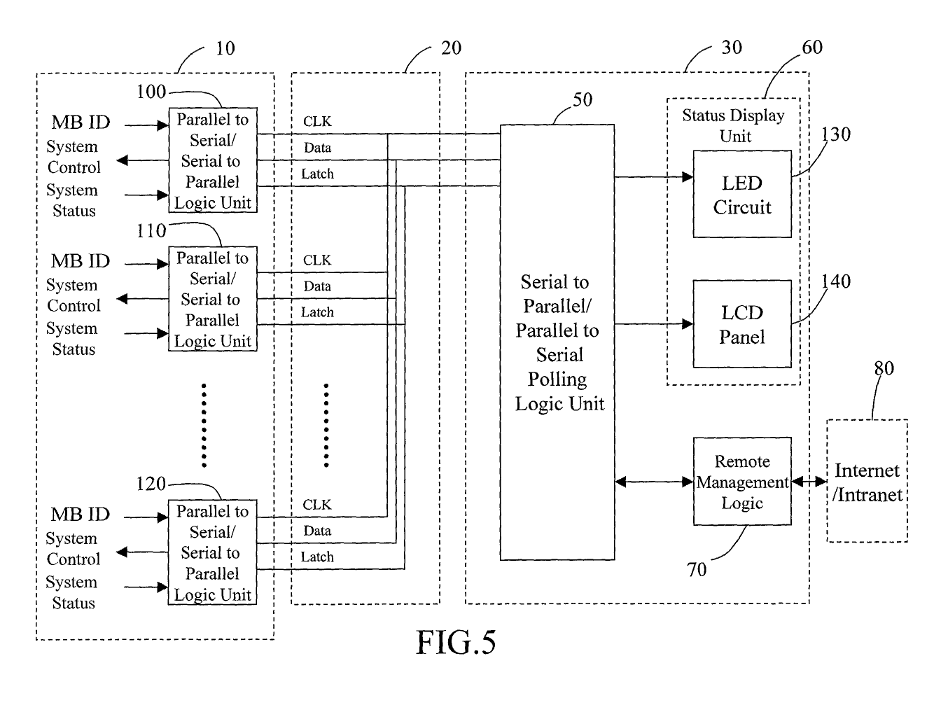

FIG. 5 is a detailed block diagram of the second embodiment of the invention. The server can be controlled remotely by a remote computer. The remote computer is connected to the remote managing logic unit 70 of the system management unit 30 through the Internet or an Intranet 80. Since the remote managing logic unit 70 is connected with the polling logic unit 50, the status of the motherboards can be monitored and controlled through the polling logic unit 50.

There are a plurality of parallel to serial logic units and serial to parallel logic units 100, 110, 120, etc. included in the motherboard section 10. These parallel to serial logic units and serial to parallel logic units are the logic transform units 40 illustrated in FIG. 3. In other words, each logic transform unit 40 includes a parallel to serial logic unit and a serial to parallel logic unit. Each parallel to serial logic/serial to parallel logic unit 100, 110 or 120 includes three output lines: a clock line, a data line and a latch line. The clock lines of each parallel to serial logic/serial to parallel logic unit are connected to the polling logic unit 50 parallel to one another. The data lines of each parallel to serial logic/serial to parallel logic unit are connected to the polling logic unit 50 parallel to one another. The latch lines are also connected to the polling logic unit 50 parallel to one another. The status display unit 60 includes an LED circuit 130 and LCD panel 140 for displaying the status signals of the motherboards.

In FIG. 5, each parallel to serial logic/serial to parallel logic unit 100, 110 or 120 is used to transfer the status signal of a motherboard to the serial to parallel logic unit included in the polling logic unit 50 through the system connection back plane 20. Finally, the status of the motherboard is displayed on the LED or LCD. The status signal of the motherboards can also be transferred to the remote computer through the remote managing logic unit 70 and the Internet or an Intranet 80. Furthermore, each parallel to serial logic/serial to parallel logic unit 100, 110 or 120 is used to receive the control signal coming from the remote computer for the system management unit 30, which is transferred by the polling logic unit 50. As a result, the system management unit 30 can monitor and control the motherboards of the server through those three lines by the connection between the remote computer and the system management unit.

In conclusion, the invention provides a monitoring and controlling system that requires only three signal lines connecting the motherboard section and the system management unit. It saves space and money because no large connection interface is required.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A system for monitoring and controlling a plurality of motherboards of a server through a system management unit, comprising:
a plurality of logic transform units, each included in said plurality of motherboards and composed of a parallel to serial logic unit for transferring status signals to said system management unit, and a serial to parallel logic unit for transferring control signals of said system management unit to said motherboard;
an polling logic unit, included in said system management unit for receiving and transferring said status signals of said plurality of motherboards transformed by said logic transform unit, and transferring said control signals of said system management unit to said logic transform unit;
a system connection back plane for connecting said logic transform units and said polling logic unit; and
a status display unit included in said system management unit and connected with said polling logic unit for receiving said status signals of said plurality of motherboards and display the status of said plurality of motherboards.

2. The system of claim 1, wherein said plurality of motherboards provide identification codes to said logic transform units for identification of said plurality of motherboards.

3. The system of claim 1, wherein each said logic transform units and said system connection back plane are connected through a clock lines, a data line and a latch line.

4. The system of claim 3, wherein said clock lines are linked in parallel and connected to said polling logic unit.

5. The system of claim 3, wherein said data lines are linked in parallel and connected to said polling logic unit.

6. The system of claim 3, wherein said latch lines are linked in parallel and connected to said polling logic unit.

7. The system of claim 1, wherein said polling logic unit further comprises:
a serial to parallel logic unit for receiving said status signals of said plurality of motherboards transferred by said logic transform units, and transferring said status signals to said status display unit; and
a parallel to serial logic unit for transferring said control signals of said system management unit.

8. The system of claim 1, wherein said polling logic unit requests said status signals of said plurality of motherboards, and displays the status of said plurality of motherboards on said status display unit.

9. The system of claim 1, wherein said status display unit comprises a light-emitting diode circuit and a liquid crystal display for displaying said status of said plurality of motherboards.

10. A system for monitoring and controlling a plurality of motherboards of a server through a system management unit and a remote computer, comprising at least:
a plurality of logic transform units, each included in said plurality of motherboards and composed of a parallel to serial logic unit for transferring status signals to said system management unit, and a serial to parallel logic unit for transferring control signals of said system management unit to said motherboard;
an polling logic unit, included in said system management unit for receiving and transferring said status signals of said plurality of motherboards transformed by said logic transform unit, and transferring said control signals of said system management unit to said logic transform unit;
a system connection back plane for connecting said logic transform units and said polling logic unit;
a status display unit included in said system management unit and connected with said polling logic unit for receiving said status signals of said plurality of motherboards and display the status of said plurality of motherboards; and
a remote managing logic unit included in said system management unit and connected with said polling logic unit for receiving said control signals from said remote computer, transferring said control signals to said plurality of motherboards, receiving said status signals of said plurality of motherboards, and transferring said status signals to said remote computer.

11. The system of claim 10, wherein said plurality of motherboards provide identification codes to said logic transform units for identification of said plurality of motherboards.

12. The system of claim 10, wherein said logic transform units and said system connection back plane are connected through a plurality of clock lines, data lines and latch lines.

13. The system of claim 12, wherein said clock lines are linked in parallel and connected to said polling logic unit.

14. The system of claim 12, wherein said data lines are linked in parallel and connected to said polling logic unit.

15. The system of claim 12, wherein said latch lines are linked in parallel and connected to said polling logic unit.

16. The system of claim 10, wherein said polling logic unit further comprises:
a serial to parallel logic unit for receiving said status signals of said plurality of motherboards transferred by said logic transform units, and transferring said status signals to said status display unit; and
a parallel to serial logic unit for transferring said control signals of said system management unit.

17. The system of claim 10, wherein said polling logic unit inquires orderly said status signals of said plurality of motherboards, and displays the status of said plurality of motherboards on said status display unit.

18. The system of claim 10, wherein said status display unit comprises a light-emitting diode circuit and a liquid crystal display for displaying said status of said plurality of motherboards.
